(19) United States
(12) Patent Application Publication
(10) Pub. No.: US 2012/0260202 A1
(43) Pub. Date: Oct. 11, 2012

(54) CUSTOMIZED LAUNCHING OF APPLICATIONS

(75) Inventors: Rachel Jiang, Redmond, WA (US); Christopher A. Glein, Seattle, WA (US); Andrew C. Jennings, Seattle, WA (US); Alper Selcuk, Bellevue, WA (US); Daniel Alan Zucker, Seattle, WA (US)

(73) Assignee: Microsoft Corporation, Redmond, WA (US)

(21) Appl. No.: 13/084,483

(22) Filed: Apr. 11, 2011

(51) Int. Cl. G06F 3/048

(52) U.S. Cl. 715/765

(57) ABSTRACT

The present application allows third party applications to have customizable entry pages. In one embodiment, an Application Programming Interface (API) is used by a locally executed application to store an application entry page and/or parameters in an application database to make the entry page of the application customized to the user. In another embodiment, an icon is automatically generated in response to the API storing the customizable entry page. In yet another embodiment, multiple icons can be used for multiple customizable entry pages of a single application.

### FIELD

The present application relates to user interfaces and, particularly, to customizing the launching of an application.

### BACKGROUND

Launching of an application is well known. For example, on a mobile phone, a user interface has a plurality of icons typically representing applications or content. Selecting one of the icons launches (i.e., opens) an application associated with the icon. Little control is provided to customize how the application is launched. In particular, when launching an application, the first page of the application is typically displayed as a default page. Yet, applications most often include multiple pages, which can be thought of as sub-pages. A simple example is an email application that includes an email page and a contacts page.

Some websites can customize their home page by retrieving locally stored information (e.g., a cookie) that includes customization parameters. Thus, the first page that is launched may immediately display a user's name that previously visited the site. However, the ability to modify the entry point of a locally stored application is not available or otherwise very limited.

Mobile phones have provided the ability to customize icons for launching system components. System components are applications that are shipped with the phone and cannot be uninstalled. An icon can be placed on a start screen to customize the entry page (i.e., default page) to the system component and the entry page can change based on user settings. However, there is no way to customize entry pages for third-party applications.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present application allows third-party applications to have customizable entry pages.

In one embodiment, an Application Programming Interface (API) is used by a locally executed application to store an application entry page and/or parameters in an application database to customize the entry page.

In another embodiment, an icon is automatically generated in response to the API storing the customizable entry page information.

In yet another embodiment, multiple icons can be used for multiple customizable entry pages of a single application.

The foregoing and other objects, features, and advantages of the invention will become more apparent from the following detailed description, which proceeds with reference to the accompanying figures.

### BRIEF DESCRIPTION OF THE DRAWINGS

FIG. 1 is an exemplary mobile phone that can be used for launching third-party applications with customized entry pages.

FIG. 2 is a flowchart of a method for customizing a launching of a third-party application.

FIG. 3 is a flowchart of a method for generating an icon to launch an application at a customized entry page.

FIG. 4 shows an example user interface of a third-party application and a view of a default screen on a client device.

FIG. 5 shows a system diagram with the interaction between an application, an operating system, an API and a database.

FIG. 6 is a flowchart of a method for launching the application.

FIG. 7 is an exemplary network that can be used in conjunction with launching applications.

### DETAILED DESCRIPTION

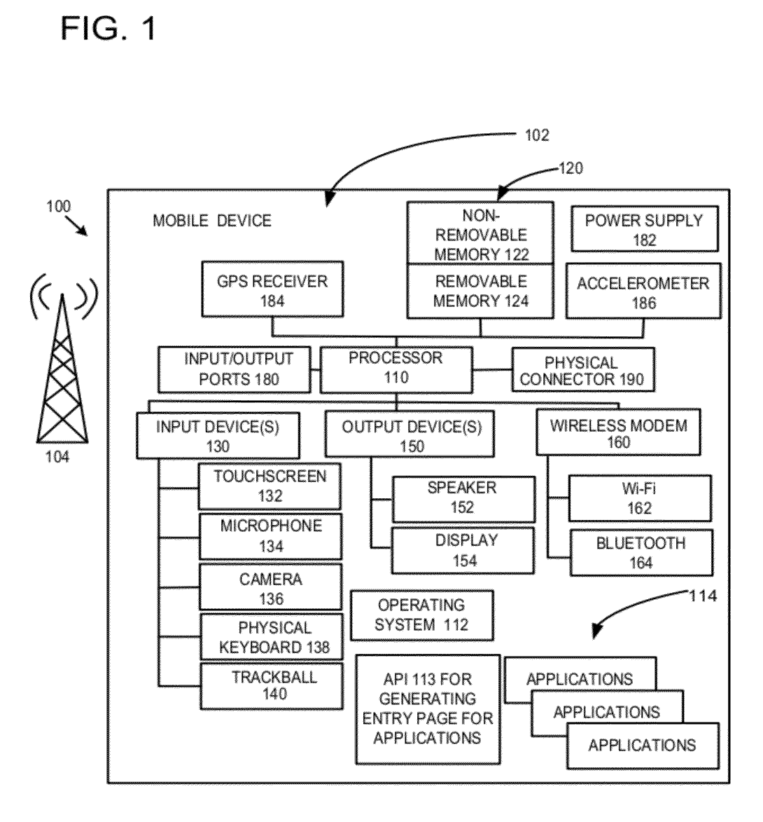

FIG. 1 is a system diagram depicting an exemplary mobile device 100 including a variety of optional hardware and software components, shown generally at 102. Any components 102 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 104, such as a cellular or satellite network.

The illustrated mobile device 100 can include a controller or processor 110 (e.g., signal processor, microprocessor, ASIC, or other control and processing logic circuitry) for performing such tasks as signal coding, data processing, input/output processing, power control, and/or other functions. An operating system 112 can control the allocation and usage of the components 102 and support for one or more application programs 114. The application programs can include common mobile computing applications (e.g., email applications, calendars, contact managers, web browsers, messaging applications), or any other computing application. An API 113 can also be used for generating a customized entry page for applications.

The illustrated mobile device 100 can include memory 120. Memory 120 can include non-removable memory 122 and/or removable memory 124. The non-removable memory 122 can include RAM, ROM, flash memory, a hard disk, or other well-known memory storage technologies. The removable memory 124 can include flash memory or a Subscriber Identity Module (SIM) card, which is well known in GSM communication systems, or other well-known memory storage technologies, such as “smart cards.” The memory 120 can be used for storing data and/or code for running the operating system 112 and the applications 114. Example data can include web pages, text, images, sound files, video data, or other data sets to be sent to and/or received from one or more network servers or other devices via one or more wired or wireless networks. The memory 120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 100 can support one or more input devices 130, such as a touch screen 132, microphone 134, camera 136, physical keyboard 138 and/or trackball 140 and one or more output devices 150, such as a speaker 152 and a display 154. Other possible output devices (not shown) can include piezoelectric or other haptic output devices. Some devices can serve more than one input/output function. For example, touchscreen 132 and display 154 can be combined in a single input/output device.

A wireless modem 160 can be coupled to an antenna (not shown) and can support two-way communications between the processor 110 and external devices, as is well understood in the art. The modem 160 is shown generically and can include a cellular modem for communicating with the mobile communication network 104 and/or other radio-based modems (e.g., Bluetooth or Wi-Fi). The wireless modem 160 is typically configured for communication with one or more cellular networks, such as a GSM network for data and voice communications within a single cellular network, between cellular networks, or between the mobile device and a public switched telephone network (PSTN).

The mobile device can further include at least one input/output port 180, a power supply 182, a satellite navigation system receiver 184, such as a Global Positioning System (GPS) receiver, an accelerometer 186, and/or a physical connector 190, which can be a USB port, IEEE 1394 (FireWire) port, and/or RS-232 port. The illustrated components 102 are not required or all-inclusive, as any components can deleted and other components can be added.

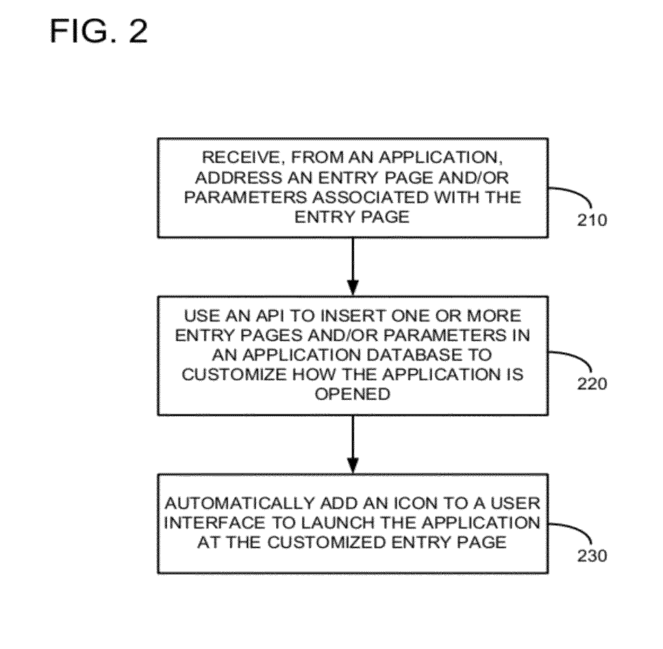

FIG. 2 is a flowchart of a method for customizing a launching of a third-party application. A third-party application is an application that was not shipped with a client device, but is downloaded or otherwise installed by the user. Such applications can be uninstalled. System components, by contrast, can be applications, but they cannot be uninstalled. An example system component is a contacts list on a mobile phone. In either case, applications are executed and run on the client device itself. By contrast, web pages, are executed or delivered by a server computer. Customizing the launching of a third-party application entails customizing which page the third-party application starts as a default page for the user or customizing how the page looks for a user.

In process block 210, an application sends (and an API receives) a navigation address and/or parameters for a customizable entry page into the application. The entry page is the first page displayed to the user after launching the application. Launching the application means that the application program is activated from the operating system's user interface. By being customizable, the user can customize what content is displayed or what page in the application is the first viewed page. For example, instead of displaying a default page associated with an application after launching, the user can select sub-pages to be viewed as an entry page. Alternatively, or in addition, the parameters can be used as input data to the page to make it further customized. In process block 220, an API uses the entry page address and/or parameters received from the application and inserts the same into an application database. Preferably, the application database is located on the client device itself, and an example structure is given below. In process block 230, an icon is automatically added to the user interface to selectably launch the application at the customized entry page.

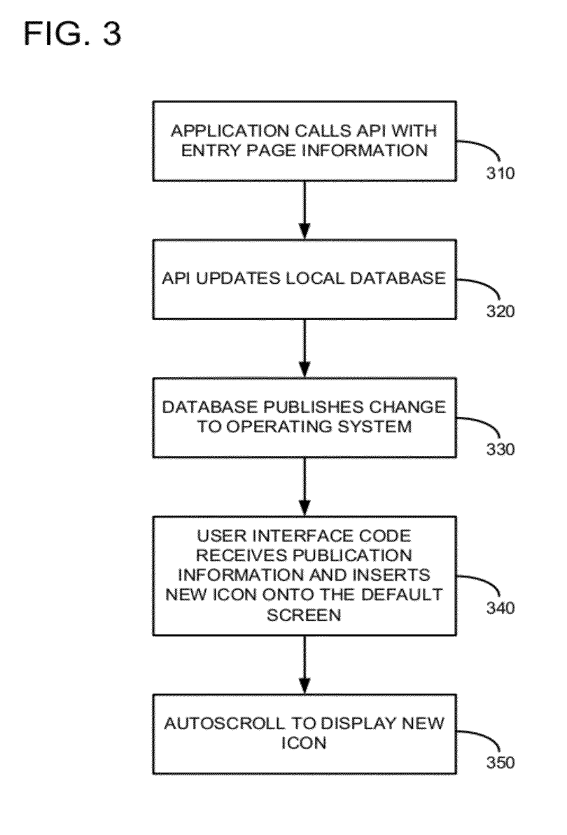

FIG. 3 shows a flowchart of a method for generating an entry page icon on the user interface. In process block 310, an application calls an API with entry page information. Example entry page information can include a navigation address and/or parameters (data) used to customize the entry page. In process block 320, the API updates a local application database. For example, the API can store the navigation address and/or parameters in association with an identifier of the application. In process block 330, the local application database publishes the change to the operating system. In process block 340, the operating system code controlling the user interface receives the publication information and inserts a new icon onto the default screen. The icon can be a static icon or a dynamic icon. Dynamic icons can appear multi-dimensional and/or display updates. In process block 350, the user interface display can autoscroll to display the new icon. When the new icon is selected, the application can launch and the customized page is the first page displayed to the user.

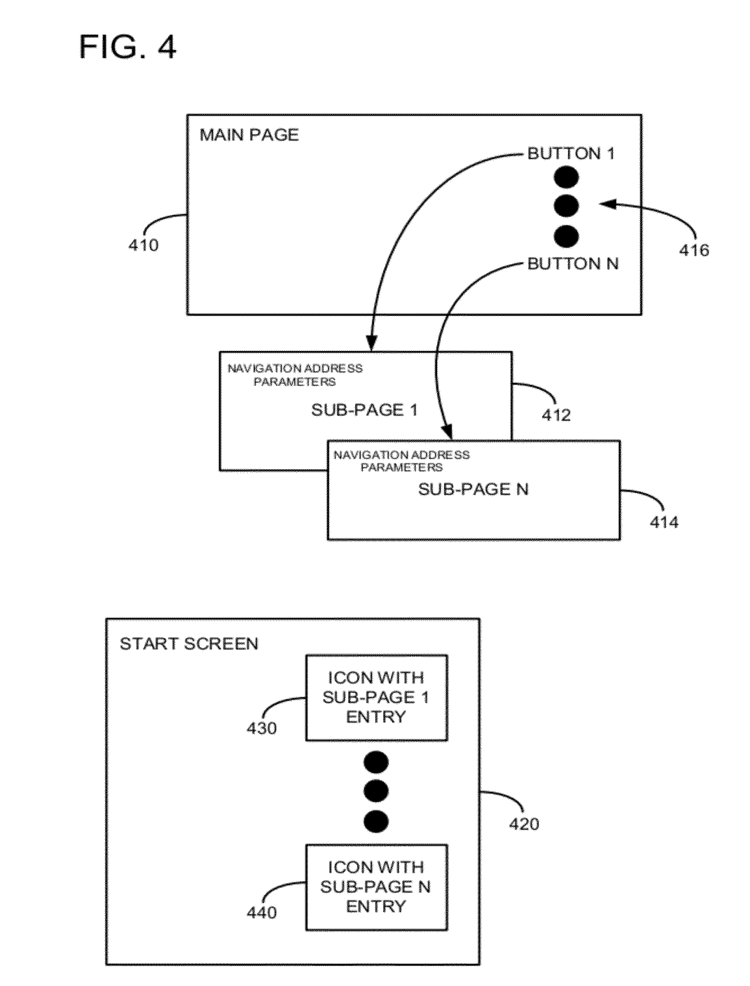

FIG. 4 is an example of a main page 410 (default page) of an application and sub-pages 412, 414. The main page has buttons, shown generally at 416, that can be depressed to display the sub-pages 412, 414. A simple example is when a user is in an application and selects a “print” button, the user interface typically displays a different page, which is either in a new window, or the same window is switched. Each sub-page has a navigation address associated therewith. Additionally, parameters can be used to further customize content displayed on the sub-page. Customization can also include using the main page as the default page with the parameters used to customize the content displayed. A start screen (also called home screen or default screen) of a client device is shown at 420. Icons are typically displayed on the start screen and are used to launch applications. Multiple icons 430 and 440 are shown for illustration and represent that any number of icons (1-N, where N is any number) can be displayed as entry points associated with the sub-pages of the application. Thus, when an icon is selected, the application launches and displays the corresponding entry page as the first page displayed. Alternatively, each icon can be associated with parameters used in customizing the pages 410, 412, 414 of the application. Other applications (not shown) can be used that have customized entry pages.

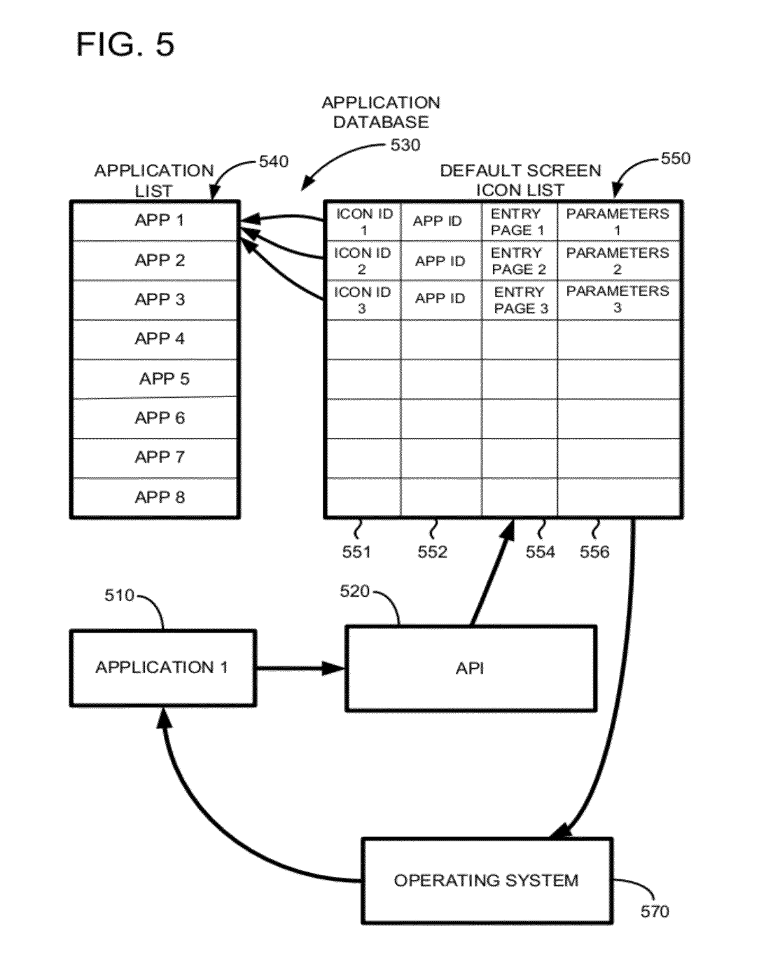

FIG. 5 shows an example system diagram that can be used for generating an entry-page icon. A third-party application is shown at 510. In order to generate a customized entry page into the application 510, the application calls an API 520. The application passes to the API a navigation address and/or parameters. Typically, the navigation address is determined by receiving user input that assigns a page to an icon. For example, when the user is on a particular sub-page, the user can select a menu item indicating the desire to make the current sub-page the default page when the application is launched. The application has an address associated with the sub-page that can be passed to the API 520. The parameters can similarly be selected by the user and passed to the API. Other information that can be passed to the API include image data, string data, and the like, which can be used to customize and generate an icon. The API 520 uses the information from the application 510 to update an application database 530. The application database 530 can take a wide variety of forms. The illustrated database includes two or more tables 540, 550. Table 540 is a list of applications that were downloaded to the client device. Table 550 is a list of icons that are on the start screen of the client device. The table 550 includes multiple fields, such as an application identifier field 551, an application identification field 552, an entry page field 554, and a parameters field 556. The icon identification field identifies each icon on the start screen. The application identification field 552 points to an application in the application table 540. As shown, multiple entries in the icon list can point to a single application. Thus, each third-party application can have multiple entry pages. The entry page field 554 is the navigation address identifying the page or sub-page of the application. The parameters field 556 includes further information to customize the application. When the user selects an icon on the user interface of the client device, an operating system 570 retrieves information from the application database 530 and uses the information to launch the customized entry page of the application 510.

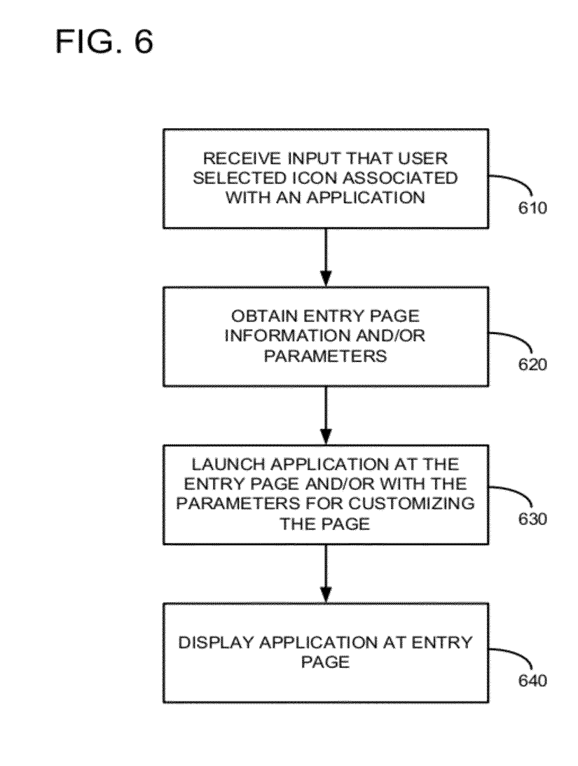

FIG. 6 shows a flowchart of a method for launching the third-party application with a customized starting page. In process block 610, input is received by the operating system that a user selected an icon. In process block 620, the application database is accessed using the icon as a key to the table that includes a list of icons. Using that table, the application associated with the icon can be identified. Additionally, the address associated with the customized starting page and/or any customization parameters can be obtained. In process block 630, the application can be launched by passing the application the entry page information and/or the customization parameters. At process block 640, the application is displayed with the corresponding customized entry page displayed.

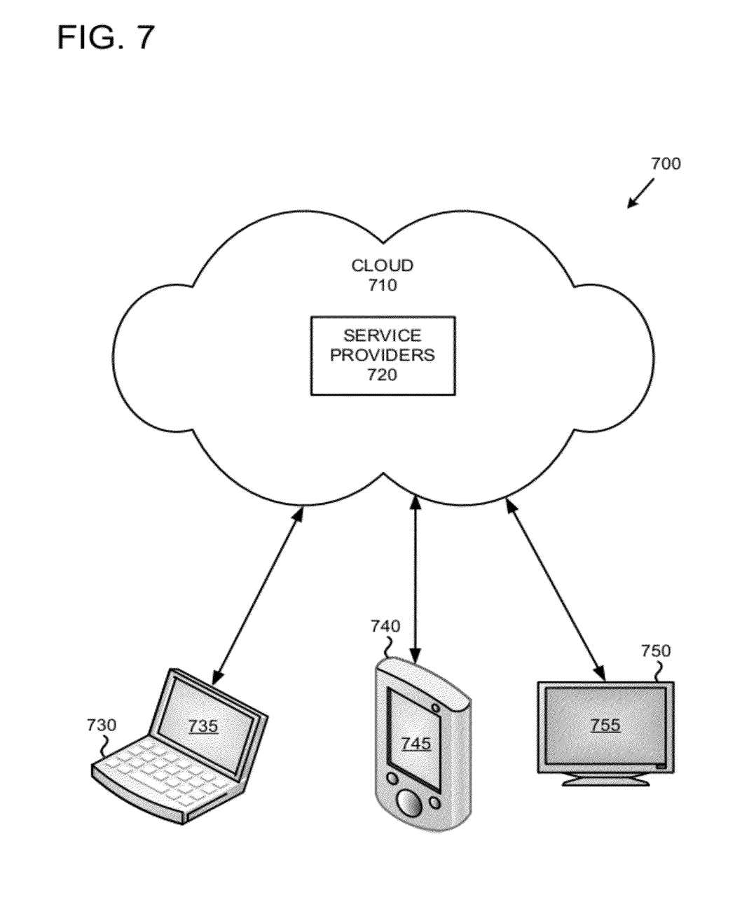

FIG. 7 illustrates a generalized example of a suitable implementation environment 700 in which described embodiments, techniques, and technologies may be implemented.

In example environment 700, various types of services (e.g., computing services) are provided by a cloud 710. For example, the cloud 710 can comprise a collection of computing devices 730, 740, 750, which may be located centrally or distributed, that provide cloud-based services to various types of users and devices connected via a network such as the Internet. The implementation environment 700 can be used in different ways to accomplish computing tasks. For example, some tasks (e.g., processing user input and presenting a user interface) can be performed on local computing devices (e.g., connected devices 730, 740, 750) while other tasks (e.g., storage of data to be used in subsequent processing) can be performed in the cloud 710. One example is that the cloud 710 can store the application database including the customizable page information. In this way, customization of an application on one device can be applied across all devices.

In example environment 700, the cloud 710 provides services for connected devices 730, 740, 750 with a variety of screen capabilities. Connected device 730 represents a device with a computer screen 735 (e.g., a mid-size screen). For example, connected device 730 could be a personal computer such as desktop computer, laptop, notebook, netbook, or the like. Connected device 740 represents a device with a mobile device screen 745 (e.g., a small size screen). For example, connected device 740 could be a mobile phone, smart phone, personal digital assistant, tablet computer, and the like. Connected device 750 represents a device with a large screen 755. For example, connected device 750 could be a television screen (e.g., a smart television) or another device connected to a television (e.g., a set-top box or gaming console) or the like. One or more of the connected devices 730, 740, 750 can include touch screen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 700. For example, the cloud 710 can provide services for one or more computers (e.g., server computers) without displays.

Services can be provided by the cloud 710 through service providers 720, or through other providers of online services (not depicted). For example, cloud services can be customized to the screen size, display capability, and/or touch screen capability of a particular connected device (e.g., connected devices 730, 740, 750).

In example environment 700, the cloud 710 provides the technologies and solutions described herein to the various connected devices 730, 740, 750 using, at least in part, the service providers 720. For example, the service providers 720 can provide a centralized solution for various cloud-based services. The service providers 720 can manage service subscriptions for users and/or devices (e.g., for the connected devices 730, 740, 750 and/or their respective users).

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method of generating an entry page icon for launching an application on a client device, comprising:
receiving from an application, a navigation address for a customizable entry page, the receiving occurring in an application programming interface;
inserting the navigation address into an application database;
automatically adding an icon to a user interface of the client device, which is usable to launch the application at the customized entry page.

2. The method of claim 1, wherein the navigation address is a first navigation address and further including receiving a second navigation address from the application, inserting the second navigation address into the application database, and automatically adding a second icon to the user interface so that the application has multiple icons associated therewith, with multiple entry pages.

3. The method of claim 1, wherein the application includes multiple pages including a main page and sub-pages and the entry page of the application is a sub-page.

4. The method of claim 1, further including receiving input that the icon was selected and launching the application from the customized entry page.

5. The method of claim 1, wherein the application database includes a list of applications, a list of icons associated with the applications, and entry pages associated with the icons.

6. The method of claim 5, further including receiving input that the icon was selected and launching the application from the customized entry page by accessing the application database, extracting the application identification associated with the icon and the entry page and passing the entry page to the application being launched.

7. The method of claim 1, wherein automatically adding the icon includes receiving a notification that the database has been changed, receiving image data associated with the entry page, and displaying the icon to the default display using the image data.

8. The method of claim 1, further including auto scrolling a default display to the new icon.

9. The method of claim 1, further including dynamically modifying the icon in response to a push notification.

10. A computer-readable storage having instructions thereon for executing the method of claim 1.

11. The method of claim 1, wherein the client device is a mobile phone.

12. A method for launching an application on a mobile phone, comprising:
using an application programming interface to receive an entry page from a locally executing application;
storing the entry page in an application database; and
automatically adding an icon to a user interface on the mobile phone in response to storing the entry page in the application database.

13. The method of claim 12, further including receiving an image from the locally executing application and using the image in the icon.

14. The method of claim 12, further including using the application programming interface to create multiple entry pages into the application, with an icon associated with each entry page.

15. The method of claim 12, wherein an entry page in the application indicates a page in the application, other than a default page, that is a first page displayed upon launching.

16. The method of claim 12, wherein storing further includes associating an application identification with the entry page in the application database.

17. The method of claim 12, further including passing the entry page to the application upon launching the icon.

18. The method of claim 12, wherein the application has a default page and multiple sub-pages, and the entry page is one of the sub-pages.

19. A method of generating an entry page for a mobile phone, comprising:
receiving a request to generate an entry page for an application;
storing the entry page in a local database together with an identification of the application using an application programming interface;
publishing that the entry page has been added to the local database;
in response to the publication, adding an icon to a user interface of the mobile phone associated with the application and the icon;
in response to detecting a selection of the icon, launching the application using the entry page to determine which page in the application to open as a default page.

20. The method of claim 19, further including downloading the application from the Internet.
